(19) United States
(12) Patent Application Publication
(10) Pub. No.: US 2025/0293899 A1
(43) Pub. Date: Sep. 18, 2025

(54) ELECTRONIC DEVICE AND CONTROL METHOD THEREFOR

(71) Applicant: Samsung Electronics Co., Ltd., Suwon-si (KR)

(72) Inventors: Jongho LEE, Suwon-si (KR); Kumchul HWANG, Suwon-si (KR)

(21) Appl. No.: 19/222,427

(22) Filed: May 29, 2025

Related U.S. Application Data
(63) Continuation of application No. PCT/KR2023/018477, filed on Nov. 16, 2023.

(30) Foreign Application Priority Data
Dec. 23, 2022 (KR) 10-2022-0183165

(51) Int. Cl. H04L 12/28; G16Y 40/30

(52) U.S. Cl. CPC H04L 12/2823; G16Y 40/30

(57) ABSTRACT

An electronic device is provided. The electronic device includes a communication interface, memory storing information about at least one package internet of things (IoT) device corresponding to each of one or more IoT devices, and storing one or more computer programs, and one or more processors communicatively coupled to the communication interface and the memory, wherein the one or more computer programs include computer-executable instructions that, when executed by the one or more processors individually or collectively, cause the electronic device to based on the sensing data corresponding to movement of a user being received from a first IoT device through the communication interface, identify whether the user is located within a preset distance from the first IoT device based on the received sensing data, based on identifying that the user is located within the preset distance from the first IoT device, identify at least one second IoT device, which is included in the at least one package IoT device of the first IoT device based on information stored in the memory, and transmit a control signal for waking up the at least one second IoT device to the at least one second IoT device through the communication interface.

### CROSS-REFERENCE TO RELATED APPLICATION(S)

This application is a continuation application, claiming priority under 35U.S.C. § 365(c), of an International application No. PCT/KR2023/018477, filed on Nov. 16, 2023, which is based on and claims the benefit of a Korean patent application number 10-2022-0183165, filed on Dec. 23, 2022, in the Korean Intellectual Property Office, the disclosure of which is incorporated by reference herein in its entirety.

### BACKGROUND

### 1. Field

The disclosure relates to an electronic device and a control method therefor. More particularly, the disclosure relates to an electronic device for waking up a package Internet of Things (IoT) device based on received sensing data and a control method therefor.

### 2. Description of Related Art

Thanks to the development of electronic technologies, various types of electronic devices have been developed and distributed. The development of an IoT technology, in which a plurality of devices are connected through a network to exchange data becomes active. A user may be provided with a high-quality service by exchanging data among a plurality of IoT devices present inside home.

Meanwhile, to operate an IoT device (e.g. a kitchen appliance) installed inside home, there was conventionally inconvenience that the user directly turns on or turns off power. For example, to wake up the kitchen appliance of which power is turned off, there was a need of an operation of pressing a power button included in the IoT device.

To resolve the above, a technology in which power of the IoT device is automatically turned on or turned off when sensing data corresponding to a specific operation of the user is inputted by using a sensor (e.g. a movement sensor) included in the IoT device has appeared.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for waking up a package Internet of Things (IoT) device based on received sensing data and a control method therefor.

Additional aspects will be set forth in part in the description which follows and, in part, will be apparent from the description, or may be learned by practice of the presented embodiments.

In accordance with an aspect of the disclosure, an electronic device is provided. The electronic device includes a communication interface, memory storing information about at least one package internet of things (IoT) device corresponding to each of at least one IoT device, and storing one or more computer programs, and one or more processors communicatively coupled to the communication interface and the memory, wherein the one or more computer programs include computer-executable instructions that, when executed by the one or more processors individually or collectively, cause the electronic device to, based on sensing data corresponding to movement of a user being received from a first IoT device through the communication interface, identify whether the user is located within a preset distance from the first IoT device based on the received sensing data, based on identifying that the user is located within the preset distance from the first IoT device, identify at least one second IoT device which is included in the at least one package IoT device of the first IoT device based on information stored in the memory, and transmit a control signal for waking up the at least one second IoT device to the at least one second IoT device through the communication interface.

One or more processors, based on identifying that the user is located within the preset distance from the first IoT device, identify at least one second IoT device that is included in the at least one package IoT device of the first IoT device based on information stored in the memory.

One or more processors transmit a control signal for waking up the at least one second IoT device to the at least one second IoT device through the communication interface.

In accordance with another aspect of the disclosure, a method of controlling an electronic device is provided. The method includes, based on sensing data corresponding to movement of a user being received from a first internet of things (IoT) device, identifying whether the user is located within a preset distance from the first IoT device based on the received sensing data, based on identifying that the user is located within the preset distance from the first IoT device, identifying at least one second IoT device which is included in at least one package IoT device of the first IoT device based on information about the at least one package IoT device corresponding to each of at least one IoT device stored in memory, and transmitting a control signal for waking up the at least one second IoT device to the at least one second IoT device.

The control method includes, based on identifying that the user is located within the preset distance from the first IoT device, identifying at least one second IoT device that is included in at least one package IoT device of the first IoT device based on information about the at least one package IoT device corresponding to each of at least one IoT device stored in memory.

The control method includes transmitting a control signal for waking up the at least one second IoT device to the at least one second IoT device.

In accordance with another aspect of the disclosure, one or more non-transitory computer readable storage media storing one or more computer programs including computer-executable instructions that, when executed by one or more processors of an electronic device individually or collectively, cause the electronic device to perform operations are provided. The operations include, based on sensing data corresponding to movement of a user being received from a first internet of things (IoT) device, identifying whether the user is located within a preset distance from the first IoT device based on the received sensing data, based on identifying that the user is located within the preset distance from the first IoT device, identifying at least one second IoT device which is included in at least one package IoT device of the first IoT device based on information about the at least one package IoT device corresponding to each of at least one IoT device stored in memory, and transmitting a control signal for waking up the at least one second IoT device to the at least one second IoT device.

The operations include, based on identifying that the user is located within the preset distance from the first IoT device, identifying at least one second IoT device that is included in at least one package IoT device of the first IoT device based on information about the at least one package IoT device corresponding to each of at least one IoT device stored in memory.

The operations include transmitting a control signal for waking up the at least one second IoT device to the at least one second IoT device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B are views schematically illustrating a method of controlling an electronic device according to various embodiments of the disclosure;

FIG. 2 is a block diagram illustrating a configuration of an electronic device according to an embodiment of the disclosure;

FIG. 3 is a flow chart illustrating a method of controlling an electronic device according to an embodiment of the disclosure;

FIG. 4 is a view illustrating a method of transmitting a control signal according to an embodiment of the disclosure;

FIG. 5 is a view illustrating a method of identifying a user according to an embodiment of the disclosure;

FIG. 6 is a view illustrating a user interface (UI) providing method according to an embodiment of the disclosure;

FIG. 7 is a sequence view illustrating an operation of a communication system according to an embodiment of the disclosure; and

FIG. 8 is a block diagram illustrating a detailed configuration of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the specification, the expression such as “have”, “may have”, “include”, or “may include” denotes the existence of such a characteristic (e.g. a numerical value, a function, an operation, or a component such as a part) and does not exclude the existence of additional characteristics.

The expression “at least one of A and/or B” should be interpreted to mean any one of “A” or “B” or “A and B”.

The expression “1st”, “2nd”, “first”, “second”, or the like used in the specification may be used to describe various elements regardless of any order and/or degree of importance, wherein such expression is used only to distinguish one element from another element and is not intended to limit the relevant element.

The description that one element (e.g. a first element) is “(operatively or communicatively) coupled with/to” or “connected to” another element (e.g. a second element) should be interpreted to include both the case where the one element is directly coupled to the another element, and the case where the one element is coupled to the another element through the other element (e.g. a third element).

A singular expression includes a plural expression, unless obviously differently defined in the context. In the application, the term such as “include” or “consist of” should be construed as designating that there are such characteristics, numbers, steps, operations, components, parts, or a combination thereof described in the specification but not as excluding in advance possibility of the existence or addition of one or more other characteristics, numbers, steps, operations, components, parts, or a combination thereof.

In the disclosure, “module” or “part” may perform at least one function or operation and may be implemented as hardware or software, or as a combination of hardware and software. Also, a plurality of “modules” or “parts” may be integrated into at least one module and implemented as at least one processor (not shown), excluding a “module” or a “part” that needs to be implemented as specific hardware.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

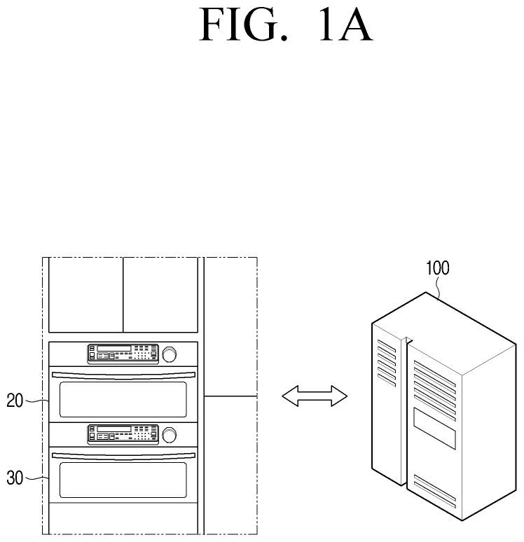

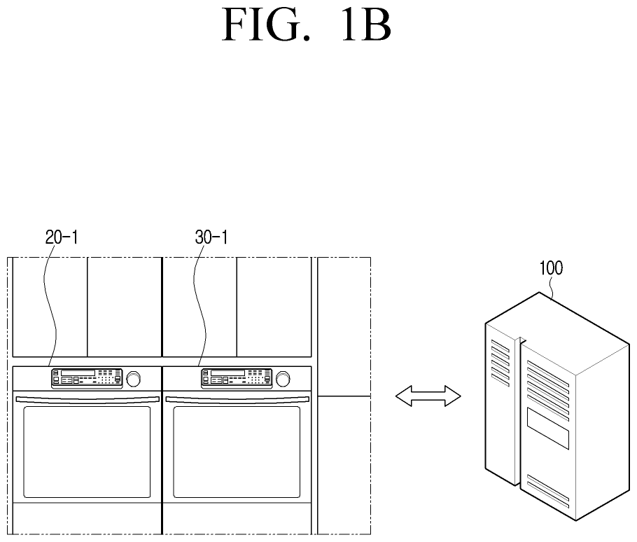

FIGS. 1A and 1B are views schematically illustrating a method of controlling an electronic device according to various embodiments of the disclosure.

Referring to FIG. 1A according to an embodiment, an electronic device 100 may be communicatively connected to at least one of a first IoT device 20 or a second IoT device 30 to transmit or receive a signal. The IoT devices including the first IoT device 20 and the second IoT device 30 may perform communication with the electronic device 100 to provide a service to a user. For example, the first IoT device 20 may be a different type of electronic device which is implemented in a form of an oven, a microwave, an air conditioner, a washing machine, a television (TV), or a refrigerator to perform communication with the electronic device 100 but is not limited thereto.

Meanwhile, according to an embodiment, the first IoT device 20 and the second IoT device 30 may be implemented as a package product and be successively installed inside home uni-directionally. For example, according to FIG. 1A, the first IoT device 20 and the second IoT device 30 may be installed inside home in an upper and lower structure, and according to FIG. 1B, a first IoT device 20-1 and a second IoT device 30-1 may be installed inside home in a left and right structure. Meanwhile, it is not limited thereto, wherein it is obvious that it may be successively installed inside home in a type of structure different from the upper and lower structure or the left and right structure.

According to an embodiment, the electronic device 100, if sensing data corresponding to movement of the user is received from the first IoT device 20 among the first IoT device 20 and the second IoT device 30, may transmit a control signal for waking up at least one of the first IoT device 20 or the second IoT device 30 based on the received sensing data. In this case, the second IoT device 30 may receive the control signal from the electronic device 100 to perform a wake-up operation without having a separate sensor.

Hereinafter, described are various embodiments of automatically turning on or turning off power of an IoT device without a separate input of the user by using a sensor included in the IoT device, and also automatically turning on or turning off power of an IoT device which is in a relation of a packaging product of the relevant IoT device without a separate user input to increase convenience of the user.

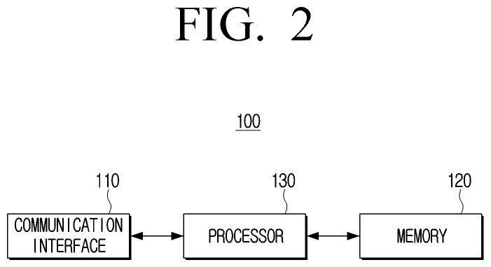

FIG. 2 is a block diagram illustrating a configuration of an electronic device according to an embodiment of the disclosure.

Referring to FIG. 2, an electronic device 100 includes a communication interface 110, memory 120, and one or more processors 130.

According to an embodiment, the electronic device 100 may be implemented as a device which processes data and performs communication with an external device such as a server but is not limited thereto. For example, the electronic device 100 may be implemented as a cloud server communicatively connected to a plurality of IoT devices but is not limited thereto, wherein the electronic device 100 may be implemented as various devices such as a smart TV, a tablet, a monitor, a smart phone, a desktop computer, or a laptop computer. According to an embodiment of the disclosure, the electronic device 100 is not limited to the aforementioned devices, and the electronic device 100 may be implemented as an electronic device 100 having two or more functions of the aforementioned devices.

According to an embodiment, the external device (not shown) may be implemented as an IoT device included inside home but is not limited thereto. For example, the IoT device may be a different type of electronic device which is implemented in a form of an oven, a microwave, an air conditioner, a washing machine, a TV, or a refrigerator to perform communication with the electronic device 100 but is not limited thereto.

The external device (not shown) may be implemented as an external device (not shown) having two or more functions of the aforementioned devices.

Meanwhile, the electronic device 100 may be communicatively connected to the external device (not shown) in various methods. According to an embodiment, a communication module for communication with the external device (not shown) may be identically implemented. For example, the electronic device 100 may communicate with the external device (not shown) by using a Bluetooth module.

The communication interface 110 may input and output various types of data. For example, the communication interface 110 may transmit or receive various types of data to/from an external device (not shown) (e.g. a source device), an external storing medium (e.g. USB memory), or an external server (e.g. webhard) through a communication method such as AP-based Wi-Fi (Wi-Fi, a Wireless LAN network), Bluetooth, Zigbee, a wired/wireless local area network (LAN), a wide area network (WAN), Ethernet, Institute of Electrical and Electronics Engineers (IEEE) 1394, a High-Definition Multimedia Interface (HDMI), a universal serial bus (USB), a mobile high-definition link (MHL), Audio Engineering Society/European Broadcasting Union (AES/EBU), an optical method, or a coaxial method.

According to an embodiment, the communication interface 110 may include a Bluetooth Low Energy (BLE) module. The BLE means a Bluetooth technology which may transmit or receive low-power and low-capacity data at a frequency band of 2.4 GHz having an arrival radius of about 10 m. Meanwhile, the disclosure is not limited thereto, wherein the communication interface 110 may include a Wi-Fi communication module. That is, the communication interface 110 may include at least one of a BLE module or a Wi-Fi communication module.

The memory 120 may store data required for various embodiments. The memory 120 may be implemented as memory embedded in the electronic device 100 according to a use for data storage or may be implemented as memory detachable from the electronic device 100. For example, data for driving the electronic device 100 is stored in memory embedded in the electronic device 100, and data for an extension function of the electronic device 100 may be stored in memory detachable from the electronic device 100.

Meanwhile, memory embedded in the electronic device 100 may be implemented as at least one of volatile memory (e.g. dynamic random access memory (RAM) (DRAM), static RAM (SRAM), or synchronous dynamic RAM (SDRAM, etc.)) or non-volatile memory (e.g. one time programmable read only memory (ROM) (OTPROM), programmable ROM (PROM), erasable and programmable ROM (EPROM), electrically erasable and programmable ROM (EEPROM), mask ROM, flash ROM, flash memory (e.g. NAND flash memory or NOR flash memory, etc.), a hard drive, or a solid state drive (SSD)). Also, memory detachable from the electronic device 100 may be implemented as a memory card (e.g. a compact flash (CF) card, a secure digital (SD) card, a micro secure digital (Micro-SD) card, a mini secure digital (Mini-SD) card, an extreme digital (xD) card, a multi-media card (MMC), etc.), external memory connectable to a USB port (e.g. USB memory), etc.

According to an embodiment, the memory 120 may store information about a package IoT device corresponding to each of at least one IoT device. Here, the first IoT device 20 may be a different type of electronic device which is implemented in a form of an oven, a microwave, an air conditioner, a washing machine, a TV, or a refrigerator and performs communication with an external server (not shown) but is not limited thereto. Meanwhile, for convenience of the description, the description is made only about the oven and the microwave hereinafter.

Information about the package IoT device is information about an IoT device set as a specific IoT device and a package device, and the package IoT device means an IoT device that performs the same operation as the specific IoT device if power of the specific IoT device is turned on or turned off. According to an embodiment, it is assumed that the first IoT device is implemented as an oven, and a package IoT device corresponding to the first IoT device is a microwave. If power of the oven is turned on by a preset input, power of the microwave set as a package device of the oven may also be turned on but is not limited thereto. Meanwhile, information about the package IoT device may be information prestored in the memory 120 upon initially setting according to an embodiment but is not limited thereto, wherein it is obvious that information about the package IoT device may be changed based on the user input.

One or more processors 130 (hereinafter, a processor) are electrically connected to the communication interface 110 and the memory 120 and controls overall operations of the electronic device 100. The processor 130 may be configured of one processor or a plurality of processors. Specifically, the processor 130 may perform operations of the electronic device 100 according to various embodiments of the disclosure by executing at least one instruction stored in the memory 120.

According to an embodiment, the processor 130 may be implemented as a Digital Signal Processor (DSP) processing a digital image signal, a microprocessor, a Graphics Processing Unit (GPU), an Artificial Intelligence (AI) processor, a Neural Processing Unit (NPU), or a time controller (TCON). Meanwhile, the disclosure is not limited thereto, and it may include one or more of a Central Processing Unit (CPU), a Micro Controller Unit (MCU), a Micro Processing Unit (MPU), a controller, an Application Processor (AP), or a Communication Processor (CP), and an advanced reduced instruction set computer (RISC) machine (ARM) processor or may be defined by the relevant terms. Also, the processor 130 may be implemented as a System on Chip (SoC) in which a processing algorithm is embedded or a Large Scale Integration (LSI) and may be implemented in a form of an Application Specific Integrated Circuit (ASIC) or a Field Programmable Gate Array (FPGA).

According to an embodiment, the processor 130 may be implemented as a DSP, a microprocessor, or a TCON. Meanwhile, the disclosure is not limited thereto, and it may include one or more of a CPU, a MCU, a MPU, a controller, an AP, or a CP, and an ARM processor or may be defined by the relevant terms. Also, the processor 130 may be implemented as a SoC in which a processing algorithm is embedded or a LSI and may be implemented in a form of a FPGA.

According to an embodiment, the processor 130 may receive sensing data from an IoT device that is an external device. According to an embodiment, the processor 130 may receive sensing data corresponding to movement of a user from a first IoT device through a communication interface 110. According to an embodiment, the first IoT device may be implemented as an oven, and the first IoT device may include at least one sensor which may detects movement of the user. For example, the processor 130 may receive sensing data obtained through a sensor included in the first IoT device through the communication interface 110. Meanwhile, according to an embodiment, a sensor included in the first IoT device may be implemented as an infrared sensor or a temperature sensor but is not limited thereto, wherein it may be implemented as a different type of sensor which may detect movement of the user.

According to an embodiment, the processor 130 may identify whether the user is positioned within a preset distance from the first IoT device based on sensing data. According to an embodiment, the processor 130, if sensing data corresponding to movement of a user being received from a first IoT device through the communication interface 110, may identify whether the user is located within a preset distance from the first IoT device based on the received sensing data. For example, the processor 130 may determine whether the user is identified based on the received sensing data and identify whether the identified user is located within the preset distance from the first IoT device.

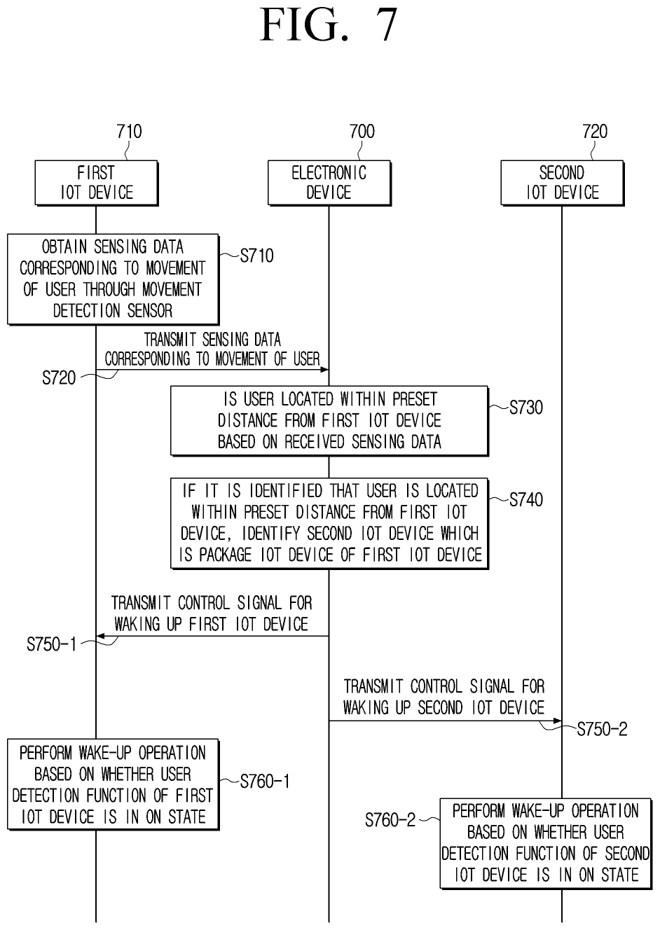

Meanwhile, it is not limited thereto, wherein according to an embodiment, the first IoT device may identify information about whether the user is located within the preset distance from the first IoT device. For example, the first IoT device may determine that the user is located within the preset distance from the first IoT device based on the received sensing data, and the processor 130 may receive information indicating that the user is located within the preset distance from the first IoT device through the communication interface 110. With respect to the above, the description is specifically described with reference to FIG. 7.

According to an embodiment, the processor 130 may identify a second IoT device which is a package IoT device of the first IoT device. According to an embodiment, the processor 130, if identifying that the user is located within the preset distance from the first IoT device, may identify a second IoT device which is the package IoT device of the first IoT device based on information stored in the memory 120. For example, the processor 130 may identify a second IoT device as at least one IoT device which is a package device of the first IoT device based on information about the package IoT device corresponding to each of at least one IoT device stored in the memory 120.

In this case, according to the embodiment, the first IoT device and the second IoT device may be implemented as a package product successively installed unidirectionally. For example, the first IoT device and the second IoT device may be implemented as a package product installed in an upper and lower structure as shown in FIG. 1A or may be implemented as a package product installed in a left and right structure as shown in FIG. 1B. Meanwhile, according to an embodiment, the first IoT device may be provided with a movement detection sensor, and the second IoT device may not be provided with the movement detection sensor. Accordingly, the processor 130 may receive sensing data only from a first IoT device.

According to an embodiment, the processor 130 may transmit a control signal for waking up the identified second IoT device to the second IoT device through the communication interface 110. According to an embodiment, the memory 120 may store information about a plurality of types of control signals corresponding to each of the plurality of IoT devices communicatively connected to the electronic device 100. The processor 130, if the second IoT device is identified, may identify a control signal for waking up the second IoT device based on information stored in the memory 120 and transmit the identified signal to the second IoT device through the communication interface 110. That is, the processor 130 may transmit a control signal including a wake-up signal to the second IoT device which does not include a sensor for detecting user movement based on sensing data received from the first IoT device including the sensor.

Meanwhile, according to an embodiment, the processor 130 may transmit a control signal for waking up the first IoT device to the first IoT device through the communication interface 110. According to an embodiment, the processor 130, if the second IoT device which is a package IoT device of the first IoT device is identified, may transmit a control signal for waking up the first IoT device and the second IoT device to each of the first IoT device and the second IoT device through the communication interface 110.

Meanwhile, it is not limited thereto, wherein according to an embodiment, the first IoT device may perform a wake-up operation based on the obtained sensing data. That is, the first IoT device may directly perform the wake-up operation through the obtained sensing data even if the control signal is not received from the electronic device 100.

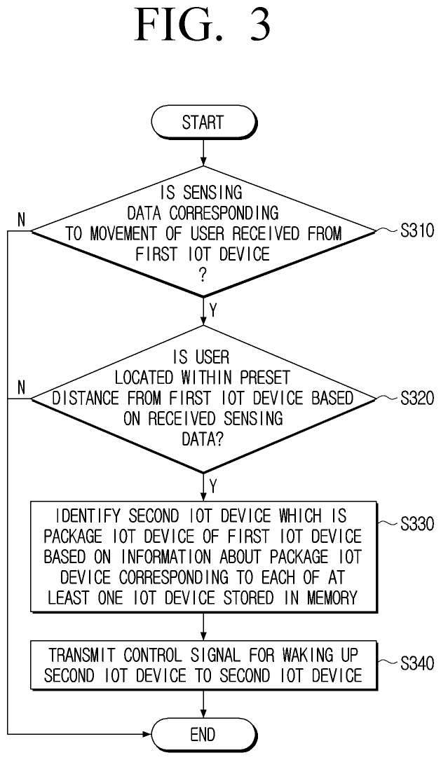

FIG. 3 is a flow chart illustrating a method of controlling an electronic device according to an embodiment of the disclosure.

Referring to FIG. 3 according to an embodiment, a control method may include identifying whether sensing data corresponding to movement of the user is received from the first IoT device in operation S310. According to the embodiment, the first IoT device is implemented as an oven, a processor 130 may receive sensing data obtained through a sensor detecting user movement included in the oven through the communication interface 110.

Then, according to the embodiment, if the sensing data corresponding to movement of the user is received in operation S310: Y, the control method may include identifying whether the user is located within the preset distance from the first IoT device based on the received sensing data in operation S320. According to an embodiment, the processor 130, if sensing data corresponding to movement of the user is received from the oven, may identify whether the user is located within the preset distance from the oven based on the received sensing data.

For example, the processor 130 may receive sensing data corresponding to the preset time section through a communication interface 110. Then, the processor may identify whether the user is present based on the received sensing data by using a preset algorithm. In this case, the processor 130 may identify whether the user is located within the present distance (e.g. 1 M) from the oven. Meanwhile, it is not limited thereto, wherein a value of the preset distance may be stored in memory 120.

According to the embodiment, the control method may include, if the user is located within the preset distance from the first IoT device in operation S320: Y, identifying a second IoT device that is a package IoT device of the first IoT device based on information about the package IoT device corresponding to each of at least one IoT device stored in memory 120 in operation S330.

According to the embodiment, the processor 130, if it is identified that the user is located within the preset distance from the oven based on sensing data received from the oven, may identify a microwave which is a package IoT device of the oven based on information about a package IoT device corresponding to each of at least one IoT device stored in the memory 120.

Then, according to the embodiment, the control method may transmit a control signal for waking up the second IoT device to the second IoT device in operation S340. According to the embodiment, the processor 130 may identify a control signal for waking up the identified microwave to a package IoT device of the oven based on information stored in the memory 120 and transmit the identified control signal to the microwave through the communication interface 110.

According to the above embodiment, user convenience may be increased by automatically turning on or turning off power of an IoT device without a separate input of the user by using a sensor included in the IoT device, and also automatically turning on or turning off power of an IoT device that is in a relation of a packaging product of the relevant IoT device without a separate user input.

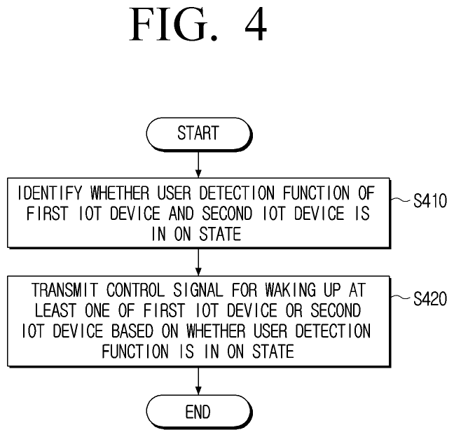

FIG. 4 is a view illustrating a method of transmitting a control signal according to an embodiment of the disclosure.

Referring to FIG. 4, according to the embodiment, in advance, the control method may include identifying whether a user detection function of each of the first IoT device and the second IoT device is in an ON state in operation S410. Here, the user detection function means a function for turning on or turning off power when the IoT devices including the first IoT device and the second IoT device detect a user even though there is no separate user input. That is, the user detection function means a function in which power is automatically turned on based on user detection.

According to the embodiment, the processor 130, if the second IoT device which is a package IoT device of the first IoT device is identified, may receive a request signal for identifying whether the user detection function of the first IoT device and the second IoT device is in an ON state from the first IoT device and the second IoT device and identify whether the user detection function of each IoT device is in an ON state based on the request signal.

Then, according to the embodiment, the control method may include transmitting a control signal for waking up at least one of the first IoT device or the second IoT device based on whether the user detection function is in an ON state in operation S420.

According to an embodiment, the processor 130, if toggle information about whether the user detection function of the first IoT device and the second IoT device is in an ON state is received from the first IoT device and the second IoT device, may transmit a control signal for waking up at least one of the first IoT device or the second IoT device to at least one of the first IoT device or the second IoT device through the communication interface 110 based on the toggle information.

For example, the processor 130, if the user detection function of the first IoT device is in an ON state, may transmit a control signal for waking up the first IoT device to the first IoT device through the communication interface 110. Otherwise, the method may include, if the user detection function of the second IoT device is in an ON state, transmitting a control signal for waking up the identified second IoT device to the second IoT device through the communication interface 110.

Otherwise, for example, the processor 130, if the user detection function of the first IoT device is in an ON state and the user detection function of the second IoT device is in an OFF state, may transmit a control signal for waking up the first IoT device to the first IoT device through the communication interface 110.

Otherwise, for example, the processor 130, if the user detection function of the second IoT device is in an ON state and the user detection function of the first IoT device is in an OFF state, may transmit a control signal for waking up the identified second IoT device to the second IoT device through the communication interface 110. That is, the processor 130 may transmit a control signal based on the state of the user detection function of each of the first IoT device and the second IoT device, respectively.

In this case, according to an embodiment, the processor 130 may transmit a control signal for providing Welcome Light together with the control signal to the first IoT device or the second IoT device.

According to an embodiment, the processor 130, if the user detection function of the first IoT device is in the ON state, may transmit a control signal for waking up the first IoT device and a control signal for providing Welcome Light to the first IoT device through the communication interface 110. Otherwise, according to the embodiment, the processor 130, if the user detection function of the second IoT device is in the ON state, may transmit a control signal for waking up the identified second IoT device and a control signal for providing Welcome Light to the second IoT device through the communication interface 110.

According to the above embodiment, the electronic device 100 may perform a preset operation on which a user need is reflected by transmitting a control signal based on a state of the user detection function of at least one IoT device communicatively connected to the electronic device 100.

Meanwhile, it is not limited thereto, wherein it may identify whether to perform a wake-up operation in the IoT device. According to an embodiment, it is assumed that the processor 130 transmits a control signal for waking up the identified second IoT device to the second IoT device. The second IoT device, if receiving a control signal, may identify whether the user detection function of the second IoT device is in an ON state, and if identifying that the user detection function of the second IoT device is in the ON state, may perform a wake-up operation based on the received control signal.

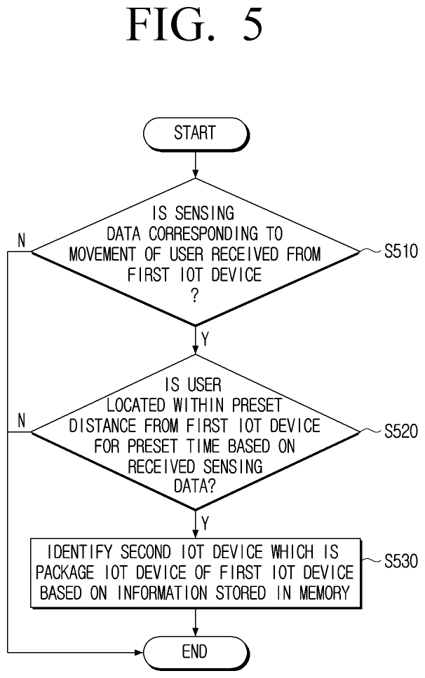

FIG. 5 is a view illustrating a method of identifying a user according to an embodiment of the disclosure.

Referring to FIG. 5 according to an embodiment, a control method may identify whether sensing data corresponding to movement of the user is received from the first IoT device in operation S510.

Then, according to an embodiment, the control method may include, if the sensing data corresponding to movement of the user is received from the first IoT device in operation S510: Y, identifying whether the user is located within the preset distance from the first IoT device for a preset time based on the received sensing data in operation S520.

According to an embodiment, a processor 130, if the sensing data corresponding to movement of the user is received from the first IoT device, may identify whether the user is located within a preset distance from the first IoT device based on the received sensing data by using a preset algorithm. In this case, the processor 130 may also identify whether the user is located from the first IoT device for the preset time. For example, the processor 130 may receive sensing data from the first IoT device for the preset time section and identify whether the user is located within the preset distance from the first IoT device for the preset time by using the received sensing data for the preset time section.

Then, according to the embodiment, the control method may include, if the user is located within the preset distance from the first IoT device for the preset time in operation S520: Y, identifying the second IoT device which is a package IoT device of the first IoT device based on the information stored in the memory 120 in operation S530, and transmitting the control signal for waking up the second IoT device to the second IoT device based on the identification.

Meanwhile, it is not limited thereto, wherein according to an embodiment, the first IoT device may identify information about whether the user is located within a preset distance from the first IoT device for a preset time. For example, the first IoT device may determine that the user is located within the preset distance from the first IoT device for the preset time based on the received sensing data, and the processor 130 may receive information indicating that the user is located within the preset distance from the first IoT device through the communication interface 110.

According to an embodiment, the electronic device 100 may transmit a control signal for waking up the second IoT device to the second IoT device if the user is located within the preset distance from the first IoT device for the preset time. Accordingly, probabilities that a wake-up operation is automatically performed may be reduced even though the user does not want.

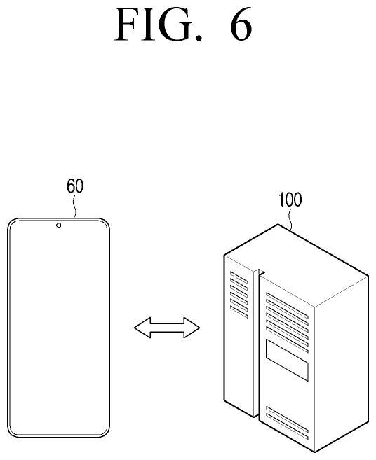

FIG. 6 is a view illustrating a UI providing method according to an embodiment of the disclosure.

Referring to FIG. 6, according to the embodiment, an electronic device 100 may transmit information indicating that a first IoT device and a second IoT device are woken up to a user terminal 60.

According to the embodiment, the processor 130, if the first IoT device and the second IoT device are woken up according to the user detection function, may transmit information indicating that the first IoT device and the second IoT device are woken up to the user terminal 60 through the communication interface 110. For example, if the first IoT device is implemented as an oven, and the second IoT device is implemented as a microwave, information indicating that the first IoT device and the second IoT device are woken up may be information corresponding to ‘power of the oven and the microwave is turned off’ but is not limited thereto.

Otherwise, according to an embodiment, the processor 130, if any one of the first IoT device and the second IoT device is woken up according to the user detection function, may transmit information indicating that the first IoT device and the second IoT device are woken up to the user terminal 60 through the communication interface 110. For example, if the oven corresponding to the first IoT device is not woken up but the microwave corresponding to the second IoT device is woken up, the processor 130 may transmit information corresponding to ‘power of the microwave is turned on’ and ‘the user detection function of the oven is in an OFF state’ to the user terminal 60 through the communication interface 110 but is not limited thereto.

Meanwhile, the user terminal 60 may provide a UI including information indicating that the first IoT device and the second IoT device are woken up according to the user detection function based on the received information. According to the embodiment, the user terminal 60, if information indicating that the first IoT device and the second IoT device are woken up is received from the processor 130, may display a UI including the received information through a display included in the user terminal 60.

Otherwise, according to the embodiment, the user terminal 60, if information corresponding to ‘power of the microwave is turned off’ and ‘the user detection function of the oven is in the OFF state’ is received, may display a UI including the received information through the display included in the user terminal 60.

According to the above embodiment, the electronic device 100 may transmit information about whether the IoT device is automatically woken up to the user terminal and may provide information related to an operation of the IoT device to the user through the user terminal, so that user convenience may be increased.

FIG. 7 is a sequence view illustrating an operation of a communication system according to an embodiment of the disclosure.

According to an embodiment, the communication system may include an electronic device 700, a first IoT device 710, and a second IoT device 720. Here, according to an embodiment, it is obvious that the first IoT device 710 and the second IoT device 720 may be implemented as a package product successively installed unidirectionally, wherein the first IoT device 710 may be provided with a movement detection sensor, and the second IoT device 720 may not be provided with the movement detection sensor, but the disclosure is not limited thereto, wherein the second IoT device 720 may be provided with the movement detection sensor, and the first IoT device 710 may not be provided with the movement detection sensor. Meanwhile, according to the embodiment, the first IoT device 710 may be implemented as an oven, and the second IoT device 720 may be implemented as a microwave, but the disclosure is not limited thereto.

Referring to FIG. 7 according to an embodiment, the first IoT device 710 may obtain sensing data corresponding to movement of the user through the movement detection sensor included in the first IoT device 710 in advance in operation S710. According to the embodiment, the movement detection sensor may be implemented as an infrared sensor or a temperature sensor but is not limited thereto, wherein it is obvious that the movement detection sensor may be implemented as a camera sensor. According to the embodiment, the first IoT device 710 may obtain sensing data corresponding to movement of the user through the movement detection sensor even in a turn-off state.

Then, according to the embodiment, the first IoT device 710 may transmit sensing data corresponding to movement of the user in operation S720. According to the embodiment, the first IoT device 710 may transmit sensing data corresponding to movement of the user during the preset time section.

Then, according to the embodiment, the electronic device 700 may identify whether the user is located within a preset distance from the first IoT device 710 based on the received sensing data in operation S730. According to the embodiment, the electronic device 700 may identify whether the user is located within the preset distance from the first IoT device 710 based on the received sensing data by using the preset algorithm.

Meanwhile, the disclosure is not limited thereto, wherein according to the embodiment, the first IoT device 710 may identify information about whether the user is located within a preset distance from the first IoT device 710, and the identified information may be received to the electronic device 700. For example, the first IoT device 710 may identify information about whether the user is located within the preset distance from the first IoT device 710 based on the received sensing data. Then, the first IoT device 710 may transmit the identified information to the electronic device 700, and the electronic device 700 may receive information indicating that the user is located within the preset distance from the first IoT device 710 through information received from the first IoT device 710. That is, at least one of the electronic device 700 or the first IoT device 710 may identify information about whether the user is located within the preset distance from the first IoT device 710.

Then, according to the embodiment, the electronic device 700, if it is identified that the user is located within the preset distance from the first IoT device 710, may identify the second IoT device 720 which is a package IoT device of the first IoT device 710 in operation S740. According to the embodiment, the electronic device 700, if it is identified that the user is located within the preset distance from the first IoT device, may identify the second IoT device 720 which is a package IoT device of the first IoT device 710 based on information about the package IoT device corresponding to each of at least one IoT device stored in the memory 120.

Then, according to the embodiment, the electronic device 700 may transmit a control signal for waking up the first IoT device 710 to the first IoT device 710 in operation S750-1 and may transmit a control signal for waking up the second IoT device 720 to the second IoT device 720 in operation S750-2. In this case, according to the embodiment, a plurality of types of control signals including a control signal for waking up the first IoT device 710 and the second IoT device 720 may be prestored in the memory 120 of the electronic device 700.

Then, according to the embodiment, the first IoT device 710 may perform a wake-up operation based on whether the user detection function of the first IoT device 710 is in an ON state in operation S760-1, and the second IoT device 720 may perform a wake-up operation based on whether the user detection function of the second IoT device 720 is in an ON state in operation S760-2. According to the embodiment, the first IoT device 710, if the user detection function is in the ON state, may perform the wake-up operation based on the received signal, and if the second IoT device 720, if the user detection function is in the ON state, may perform the wake-up operation based on the received signal. Meanwhile, according to the embodiment, a control signal corresponding to a Welcome Light operation together with a wake-up control signal may be received, and in this case, the first IoT device 710 and the second IoT device 720 may perform the Welcome Light operation together with the wake-up operation.

Meanwhile, the disclosure is not limited thereto, and according to an embodiment, it is obvious that the electronic device 700 may receive information about whether the user detection function of the first IoT device 710 and the second IoT device 720 is in an ON state from each of the first IoT device 710 and the second IoT device 720 and may transmit a control signal based on the information.

For example, the electronic device 700, if the second IoT device 720 is identified, may receive information about whether the user detection function of the first IoT device 710 and the second IoT device 720 is in the ON state from each of the first IoT device 710 and the second IoT device 720. Then, if it is identified that the user detection function of the first IoT device 710 and the second IoT device 720 is in the ON state, the electronic device 700 may transmit a control signal for waking up the first IoT device 710 to the first IoT device 710 and may transmit a control signal for waking up the second IoT device 720 to the second IoT device 720.

Otherwise, for example, if it is identified that the user detection function of the first IoT device 710 and the second IoT device 720 is in the OFF state, the electronic device 700 may not transmit a control signal for waking up the first IoT device 710 and the second IoT device 720.

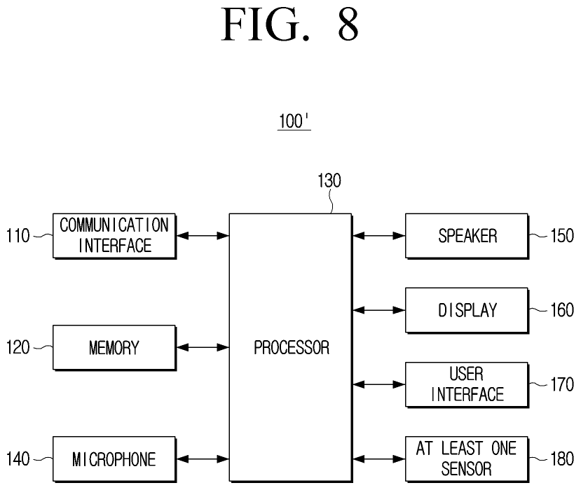

FIG. 8 is a block diagram illustrating a detailed configuration of an electronic device according to an embodiment of the disclosure.

Referring to FIG. 8, the electronic device 100′ includes a communication interface 110, memory 120, one or more processors 130, a microphone 140, a speaker 150, a display 160, a user interface 170, and at least one sensor 180. The detailed description of components overlapped with the components shown in FIG. 2 among components shown in FIG. 8 is omitted.

The microphone 140 may mean a module obtaining and converting sound to an electric signal and may be a condenser microphone, a ribbon microphone, a moving coil microphone, a piezoelectric element microphone, a carbon microphone, or a Micro Electro Mechanical System (MEMS) microphone. Also, the microphone may be implemented in an omnidirectional method, a bidirectional method, a unidirectional method, a sub cardioid method, a super cardioid method, or a hyper cardioid method.

There may be various embodiments in which an electronic device 100′ performs an operation corresponding to a user voice signal received through the microphone 140.

As an example, the electronic device 100′ may control the display 160 based on the user voice signal received through the microphone 140. For example, if a user voice signal is received for displaying a content A, the electronic device 100′ may control the display 160 to display the content A.

As another example, the electronic device 100′ may control an external display device connected to the electronic device 100′ based on the user voice signal received through the microphone 140. Specifically, the electronic device 100′ may provide a control signal for controlling an external display device such that an operation corresponding to the user voice signal is performed in the external display device and may transmit the provided control signal to the external display device. Here, the electronic device 100′ may store a remote control application for controlling the external display device. Further, the electronic device 100′ may transmit the provided control signal to the external display device by using at least one communication method among the Bluetooth, Wi-Fi, or infrared light. For example, if a user voice signal for displaying the content A is received, the electronic device 100′ may transmit a control signal for controlling the external display device to display the content A to the external display device. Here, the electronic device 100′ may mean various terminal devices which may install a remote control application such as a smart phone or an AI speaker.

As the other example, the electronic device 100′ may use a remote control device to control the external display device connected to the electronic device 100′ based on the user voice signal received through the microphone 140. Specifically, the electronic device 100′ may transmit a control signal for controlling the external display device to the remote control device so that the operation corresponding to the user voice signal is performed in the external display device. Further, the remote control device may transmit the control signal received from the electronic device 100′ to the external display device. For example, if the user voice signal for displaying the content A is received, the electronic device 100′ may transmit a control signal for controlling the external display device to display the content A to the remote control device, and the remote control device may transmit the received control signal to the external display device.

The speaker 150 may be composed of a tweeter for playing a high range of sound, a mid-range for playing a mid-range of sound, a woofer for playing a low range of sound, a sub-woofer for playing the lowest range of sound, an enclosure for controlling resonance, a crossover network for dividing an electric signal frequency inputted into the speaker according to its range, etc.

The speaker 150 may output a sound signal to the outside of the electronic device 100′. The speaker 150 may play a multi-media content and a record and may output various alarm sound, voice messages, etc. The electronic device 100′ may include an audio output device such as the speaker 150 but may include an output device such as an audio output terminal. In particular, the speaker 150 may provide obtained information, information processed and produced based on the obtained information, a response result or an operation result about a user voice, or the like in a voice from.

The display 160 may be implemented as a display including a spontaneous emission element or a display including a non-spontaneous emission element and backlight. For example, the display may be implemented as various types of displays such as a Liquid Crystal Display (LCD), an Organic Light Emitting Diode (OLED) display, a Light Emitting Diode (LED), a micro LED, a mini LED, a Plasma Display Panel (PDP), a Quantum Dot (QD) display, and a Quantum Dot Light-Emitting Diode (QLED). The display 160 may include a driving circuit which may be implemented in a form such as an a-si thin film transistor (TFT), a low temperature poly silicon (LTPS) TFT, or an organic TFT (OTFT), a backlight unit, or the like together. Meanwhile, the display 160 may be implemented as a touch screen coupled to a touch sensor, a flexible display, a rollable display, a 3D display, a display in which a plurality of display modules are physically connected, or the like. The processor 130 may control the display 160 to output the obtained output image according to the various embodiments. Here, the output image may be a high resolution image of 4K or 8K or more.

Meanwhile, according to another embodiment, the electronic device 100′ may not include the display 160. The electronic device 100′ may be connected to the external display device and may transmit an image or a content stored in the electronic device 100′ to the external display device. Specifically, the electronic device 100′ may transmit the image or content together with the control signal for controlling the external display device to display the image or content to the external display device.

Here, the external display device may be connected through the electronic device 100′ and the communication interface 110 or an input/output (I/O) interface (not shown). For example, the electronic device 100′ may not include a display such as a Set Top Box (STB). Also, the electronic device 100′ may include a small display which may display only simple information such as text information. Here, the electronic device 100′ may transmit the image or content to the external display device wiredly or wirelessly through the communication interface 110 or may transmit the same to the external display device through I/O interface (not shown).

The user interface 170 is a component by which the electronic device 100′ performs interaction with the user. For example, the user interface 170 may include at least one of a touch sensor, a motion sensor, a button, a jog dial, a switch, a microphone, or a speaker but is not limited thereto.

At least one sensor 180 (hereinafter, referred to as a sensor) may include various types of a plurality of sensors. The sensor 180 may measure physical quantity or detect an operation state of the electronic device 100′ to convert the measured or detected information to an electric signal. The sensor 180 may include a camera, wherein the camera may include a lens focusing on visible light and other optical signals reflected and received by an object with an image sensor and the image sensor which may detect visible light and other optical signals. Here, the image sensor may include a pixel array of two dimensional (2D) divided into a plurality of pixels. Otherwise, the at least one sensor 180 may include a temperature sensor or an infrared sensor.

According to the above embodiment, user convenience may be increased by automatically turning on or turning off power of an IoT device without a separate input of the user by using a sensor included in the IoT device, and also automatically turning on or turning off power of an IoT device that is in a relation of a packaging product of the relevant IoT device without a separate user input.

Meanwhile, the aforementioned methods according to the various embodiments of the disclosure may be implemented in a form of an application installable in the existing electronic device. Also, the methods according to the various embodiments of the disclosure as aforementioned may be performed by using a deep learning-based trained neural network (or a deep trained neural network), that is, a learning network model. Also, the aforementioned methods according to the various embodiments of the disclosure may be implemented only with a software upgrade or a hardware upgrade with respect to the existing electronic device. Also, it is possible to implement the various examples of the disclosure as above through an embedded server included in the electronic device or an external server of the electronic device.

Meanwhile, according to an embodiment of the disclosure, the various embodiments described above may be implemented as software including instructions stored in a machine (e.g. computer) readable storage medium. The machine refers to a device which calls instructions stored in a storage medium and is operable according to the called instructions, wherein it may include the display device (e.g. a display device A) according to the disclosed embodiments. If the instructions are executed by a processor, the processor may perform a function corresponding to the instructions directly or by using other components under control of the processor. The instructions may include a code provided or executed by a compiler or an interpreter. The machine readable storage medium may be provided in a form of a non-transitory storage medium. Here, the term ‘non-transitory’ merely means that the storage medium does not include a signal and is tangible, wherein the term does not distinguish a case that data is stored in the storage medium semipermanently from a case that data is stored in the storage medium temporarily.

Also, according to an embodiment, a method according to the various embodiment described as above may be provided to be included in a computer program product. The computer program product may be traded between a seller and a buyer as goods. The computer program product may be distributed in a form of a machine readable storage medium (e.g. compact disc read only memory (CD-ROM)) or may be on-line distributed via an application store (e.g. Play Store™). In the case of on-line distribution, at least part of the computer program product may be stored at least temporarily or may be provided temporarily in a storage medium such as memory of a server of a manufacturer, a server of an application store, or a relay server.

Also, each of components (e.g. a module or a program) according to the various embodiments above may be configured as a single item or a plurality of items, wherein a partial subcomponent of the aforementioned relevant subcomponents may be omitted, or another subcomponent may be further included in various embodiments. Mostly or additionally, some components (e.g. a module or a program) may be integrated into one item and may identically or similarly perform a function implemented by each of the relevant components before the integration. According to various embodiments, operations performed by a module, a program, or another component may be executed sequentially, in parallel, repetitively, or heuristically, at least part of the operations may be executed in different orders or be omitted, or another operation may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication interface;
memory storing information about at least one package internet of things (IoT) device corresponding to each of at least one IoT device, and storing one or more computer programs; and
one or more processors communicatively coupled to the communication interface and the memory,
wherein the one or more computer programs include computer-executable instructions that, when executed by the one or more processors individually or collectively, cause the electronic device to:
based on sensing data corresponding to movement of a user being received from a first IoT device through the communication interface, identify whether the user is located within a preset distance from the first IoT device based on the received sensing data,
based on identifying that the user is located within the preset distance from the first IoT device, identify at least one second IoT device which is included in the at least one package IoT device of the first IoT device based on information stored in the memory, and
transmit a control signal for waking up the at least one second IoT device to the at least one second IoT device through the communication interface.

2. The electronic device of claim 1,
wherein the first IoT device and the at least one second IoT device are implemented as a package product successively installed unidirectionally, and
wherein the first IoT device is provided with a movement detection sensor, and the at least one second IoT device is not provided with the movement detection sensor.

3. The electronic device of claim 1, wherein the one or more computer programs further include computer-executable instructions that, when executed by the one or more processors individually or collectively, cause the electronic device to:
based on the at least one second IoT device being identified, transmit a control signal for waking up the first IoT device and the at least one second IoT device to each of the first IoT device and the at least one second IoT device through the communication interface.

4. The electronic device of claim 1,
wherein the one or more computer programs further include computer-executable instructions that, when executed by the one or more processors individually or collectively, cause the electronic device to:
identify whether a user detection function of the first IoT device and the at least one second IoT device is in an ON state, and
transmit a control signal for waking up at least one of the first IoT device or the at least one second IoT device to at least one of the first IoT device or the at least one second IoT device based on whether the user detection function is in the ON state, and
wherein the user detection function is:
a function in which power is automatically turned on based on user detection.

5. The electronic device of claim 4, wherein the one or more computer programs further include computer-executable instructions that, when executed by the one or more processors individually or collectively, cause the electronic device to:
based on the user detection function of the first IoT device being in the ON state, transmit a control signal for waking up the first IoT device to the first IoT device through the communication interface; and
based on the user detection function of the at least one second IoT device being in the ON state, transmit a control signal for waking up the identified second IoT device to the at least one second IoT device through the communication interface.

6. The electronic device of claim 5, wherein the one or more computer programs further include computer-executable instructions that, when executed by the one or more processors individually or collectively, cause the electronic device to:
based on the user detection function of the first IoT device being in the ON state, transmit a control signal for waking up the first IoT device and a control signal for providing Welcome Light to the first IoT device through the communication interface; and
based on the user detection function of the at least one second IoT device being in the ON state, transmit a control signal for waking up the identified second IoT device and a control signal for providing Welcome Light to the at least one second IoT device through the communication interface.

7. The electronic device of claim 1, wherein the one or more computer programs further include computer-executable instructions that, when executed by the one or more processors individually or collectively, cause the electronic device to:
based on the sensing data corresponding to movement of the user being received from the first IoT device through the communication interface, identify whether the user is located within the preset distance from the first IoT device for a preset time based on the received sensing data; and
based on identifying that the user is located within the preset distance from the first IoT device for the preset time, identify the at least one second IoT device which is included in the at least one package IoT device of the first IoT device based on the information stored in the memory.

8. The electronic device of claim 4,
wherein the one or more computer programs further include computer-executable instructions that, when executed by the one or more processors individually or collectively, cause the electronic device to:
based on the first IoT device and the at least one second IoT device being woken up in accordance with the user detection function, transmit information indicating that the first IoT device and the at least one second IoT device are woken up to a user terminal through the communication interface, and wherein the user terminal:
provides a UI including the information indicating that the first IoT device and the at least one second IoT device are woken up in accordance with the user detection function based on the transmitted information.

9. A method of controlling an electronic device, the method comprising:
based on sensing data corresponding to movement of a user being received from a first internet of things (IoT) device, identifying whether the user is located within a preset distance from the first IoT device based on the received sensing data;
based on identifying that the user is located within the preset distance from the first IoT device, identifying at least one second IoT device which is included in at least one package IoT device of the first IoT device based on information about the at least one package IoT device corresponding to each of at least one IoT device stored in memory; and
transmitting a control signal for waking up the at least one second IoT device to the at least one second IoT device.

10. The method of claim 9,
wherein the first IoT device and the at least one second IoT device are implemented as a package product successively installed unidirectionally, and
wherein the first IoT device is provided with a movement detection sensor, and the at least one second IoT device is not provided with the movement detection sensor.

11. The method of claim 9, further comprising:
based on the at least one second IoT device being identified, transmitting a control signal for waking up the first IoT device and the at least one second IoT device to each of the first IoT device and the at least one second IoT device.

12. The method of claim 9, further comprising:
identifying whether a user detection function of each of the first IoT device and the at least one second IoT device is in an ON state,
wherein the transmitting includes:
transmitting a control signal for waking up at least one of the first IoT device or the at least one second IoT device to at least one of the first IoT device or the at least one second IoT device based on whether the user detection function is in the ON state, and
wherein the user detection function includes:
a function in which power is automatically turned on based on user detection.

13. The method of claim 12, wherein the transmitting includes:
based on the user detection function of the first IoT device being in the ON state, transmitting a control signal for waking up the first IoT device to the first IoT device; and
based on the user detection function of the at least one second IoT device being in the ON state, transmitting a control signal for waking up the identified second IoT device to the at least one second IoT device.

14. The method of claim 13,
wherein the transmitting to the first IoT device includes:
based on the user detection function of the first IoT device being in the ON state, transmitting a control signal for waking up the first IoT device and a control signal for providing Welcome Light to the first IoT device, and
wherein the transmitting to the at least one second IoT device includes:
based on the user detection function of the at least one second IoT device being in the ON state, transmitting a control signal for waking up the identified second IoT device and a control signal for providing Welcome Light to the at least one second IoT device.

15. The method of claim 9,
wherein the identifying whether to be located within the preset distance includes:
based on the sensing data corresponding to movement of the user being received from the first IoT device, identifying whether the user is located within the preset distance from the first IoT device for a preset time based on the received sensing data, and
wherein the identifying the at least one second IoT device includes:
based on identifying that the user is located within the preset distance from the first IoT device for the preset time, identifying the at least one second IoT device which is included in the at least one package IoT device of the first IoT device based on the information stored in the memory.

16. The method of claim 12, further comprising
based on the first IoT device and the at least one second IoT device being woken up in accordance with the user detection function, transmitting information indicating that the first IoT device and the at least one second IoT device are woken up to a user terminal.

17. The method of claim 16, wherein the user terminal provides a UI including the information indicating that the first IoT device and the at least one second IoT device are woken up in accordance with the user detection function based on the transmitted information.

18. One or more non-transitory computer-readable storage media storing one or more computer programs including computer-executable instructions that, when executed by one or more processors of an electronic device individually or collectively, cause the electronic device to perform operations, the operations comprising:
based on sensing data corresponding to movement of a user being received from a first internet of things (IoT) device, identifying whether the user is located within a preset distance from the first IoT device based on the received sensing data;
based on identifying that the user is located within the preset distance from the first IoT device, identifying at least one second IoT device which is included in at least one package IoT device of the first IoT device based on information about the at least one package IoT device corresponding to each of at least one IoT device stored in memory; and
transmitting a control signal for waking up the at least one second IoT device to the at least one second IoT device.

19. The one or more non-transitory computer-readable storage media of claim 18, the operations further comprising:
based on the at least one second IoT device being identified, transmitting a control signal for waking up the first IoT device and the at least one second IoT device to each of the first IoT device and the at least one second IoT device.

20. The one or more non-transitory computer-readable storage media of claim 18, the operations further comprising:
identifying whether a user detection function of each of the first IoT device and the at least one second IoT device is in an ON state,
wherein the transmitting includes:
transmitting a control signal for waking up at least one of the first IoT device or the at least one second IoT device to at least one of the first IoT device or the at least one second IoT device based on whether the user detection function is in the ON state, and
wherein the user detection function is:
a function in which power is automatically turned on based on user detection.
